(19) United States
(12) Patent Application Publication
(10) Pub. No.: US 2008/0209060 A1
(43) Pub. Date: Aug. 28, 2008

(54) Method For Downloading With an Advertising Insert and Specific Player

(76) Inventors: Lassad Toumi, Paris (FR); Nikolay Kovalskiy, Moskow (RU)

Correspondence Address: BLANK ROME LLP, 600 NEW HAMPSHIRE AVENUE, N.W., WASHINGTON, DC, 20037, US

(21) Appl. No.: 11/597,293

(22) PCT Filed: May 25, 2005
(86) PCT No.: PCT/FR2005/050363

§ 371 Date: Oct. 31, 2007

(30) Foreign Application Priority Data
May 25, 2004 (FR) 0405637

(51) Int. Cl. G06F 15/16; H04L 9/00

(52) U.S. Cl. 709/231; 713/150

(57) ABSTRACT

The invention relates to a method of downloading at least one digital file from a digital network using at least one server and an external device, which are connected to the network. The method includes the steps of downloading the digital file through an external device and displaying an advertisement. The step of displaying the advertisement takes place during the downloading step and the advertisement is not integrated into the download digital file and is streamed over the network. Furthermore, the method uses a mechanism for blocking the digital files.

This invention relates to digital file downloading over the Internet.

This invention is related more specifically to a process allowing the insertion of an advertisement during the downloading of a digital file, the digital file is withheld as long as the advertisement has not been consumed, i.e at least entirely visualised.

A process and a system for the dynamic modification of digital files within a file sharing network such as peer to peer, was already known of through patent application no. U.S. 2004/0 024 727 (Don Bowman). Said digital files are modified by adding an advertisement before they reach the final user, or are modified by adding audio artifacts which may be withdrawn after the payment of a license right for the file.

A process, providing multimedia files combined with advertising, over the Internet, was already known of through patent application no. U.S. 2003/0 014 310 (June Kee Jung). The invention which lead to that patent application allows users to download multimedia files free of charge or at a low cost and allows announcers effectively to broadcast their advertisements to users by providing audio files, video files etc containing advertisements to the users. When the users play the downloaded multimedia files they see or hear the advertisements.

A program, a process and a system allowing to advertise over the Internet is known of in its technical aspects through patent application no. PCT WO 01/16666. This process provides digital advertisements integrated in multimedia files downloaded over the Internet, and allows companies to generate profits from these advertisements instead of or as well as profits generated by the direct sales of their products. That process, program and system create a new norm allowing to integrate digital advertising contents into a multimedia file.

A digital file downloading solution is also known through patent application no. WO 01/57 705. The process starts by combining within one digital file the requested multimedia file with an advertisement file. The resulting file is then downloaded and advertisement appears during the download and/or when the file is played back at a later time.

These different methods provide solutions whereby the advertisement is integrated into the digital file in order to form a single digital file. From the users' point of view, these solutions “pollute” the digital file, given that the advertisement is also read upon each reading of the file.

A process, free from any advertising, to protect a file is also known through patent application no. GB 2 386 521.

Furthermore, a process and device for the downloading of an advertisement at the time of access to a web page by a user is known through patent application no. U.S. Pat. No. 6,687,737. This solution cannot be applied in the case of the downloading of a multimedia file, requiring control over its performance conditionally to the display of one or several advertisements.

Posting of advertisements processes at the same time as the download of a web page or file are also known of through patent applications no. U.S. 2003/033 380 and no. WO 01/27 824. The inconvenience of these solutions resides in the fact that once the file has been downloaded, no further control over the file itself is possible.

Previous technologies already described through patent application no. PCT WO 01/65526, a system and a process allowing to provide multimedia contents to computers via a computer network, such as the Internet, carrying a new media broadcaster that may be downloaded to a user's personal computer. This media broadcaster includes a user interface allowing a listener to search through a database of online media selections and to create a personalised broadcasting list containing exactly the musical selections chosen by him. The multimedia content distribution system provides advertisements which remain visible on the display screen of the user's computer at all times as soon as the application is opened, especially when music selections are provided to the user. The advertisements are displayed in a window which remains at all times at the highest level of the windows on the user's display screen, even if the user is running one or several other programs on his computer. This solution offers a permanent display of an advertisement when the multimedia contents are downloaded or read and does not offer a solution for easy management of the display conditions of the advertising, for example by displaying this advertisement only for a given number of runs of the downloaded file.

This invention intends to remedy the inconvenience of previous technology by offering a digital file download process without the adding of advertisements to the files concerned. Files are modified before the downloading stage, i.e the stage during which an advertisement is displayed. The “consuming” of said advertisement allows the exploitation of the file and thus allows a normal use of the digital file downloaded.

To this effect, the invention concerns in its most general meaning a process of downloading of at least one digital file on a digital network putting to contribution at least one server and a remote device, connected to the aforementioned network, including a stage of downloading of the digital file or files by the aforementioned device and a stage during which an advertisement is displayed, with the following characteristics:
said stage of advertisement display takes place during said downloading stage,
said advertisement is not integrated with said downloaded digital file and is broadcast continuously on the network (streaming),
also, the process implements, at the level of the digital file, methods for blocking its use.

Preferably, said methods implemented in order to block the use of the digital file or files, include a stage of encrypting of the file to be downloaded.

Pursuant to a given version of the process, said methods implemented in order to block the use of the the digital files or files include a stage of encapsulation in an owner format of the file to be downloaded.

Advantageously, described methods implement a way to block the use of the digital file or files are disactivated by the use of a specific plug-in.

Following a particular mode of implementation, at least one of the mentioned files is a multimedia file.

Following another mode of implementation, the file in question is an mp3 format file.

Preferably, said network is the Internet.

Following a mode of implementation, the downloading of the file is initiated after the advertisement is displayed so that the downloading and the display end at the same time.

In another mode of implementation, the process includes, following the display of said advertisement, a stage of transmission of a decrypting key by the server to the remote device if the following parameters are verified:
the requesting user's IP address corresponds to the user requesting the advertisement broadcasted,
the advertisement has been displayed in its entirety

In particular, the process includes a stage of withdrawal of said methods implemented for blocking the use of the file when the advertisement initiated by the running of the file has been run a defined number of times.

The invention can be understood more fully by referring to the description, included hereafter as an illustration of a mode of implementation of the invention, in reference to the figures attached hereto:

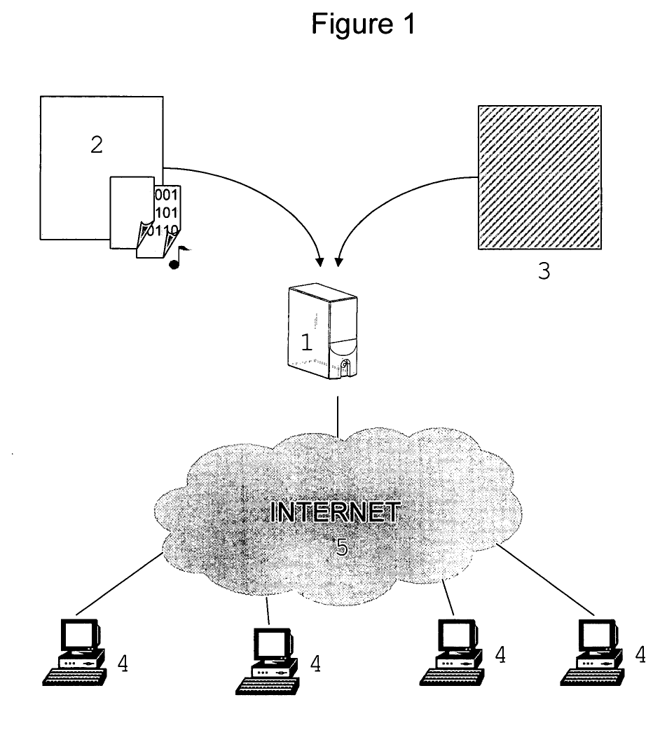

FIG. 1 contains a description of the general manner in which this invention functions;

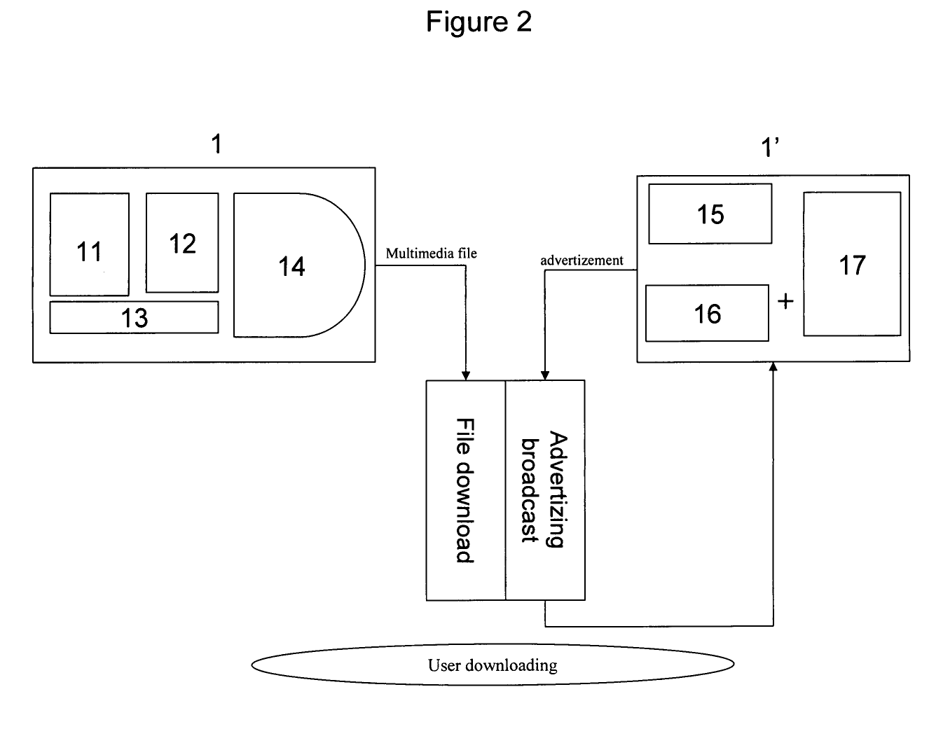

FIG. 2 contains a description of the working architecture of the server or servers used for implementing the invention;

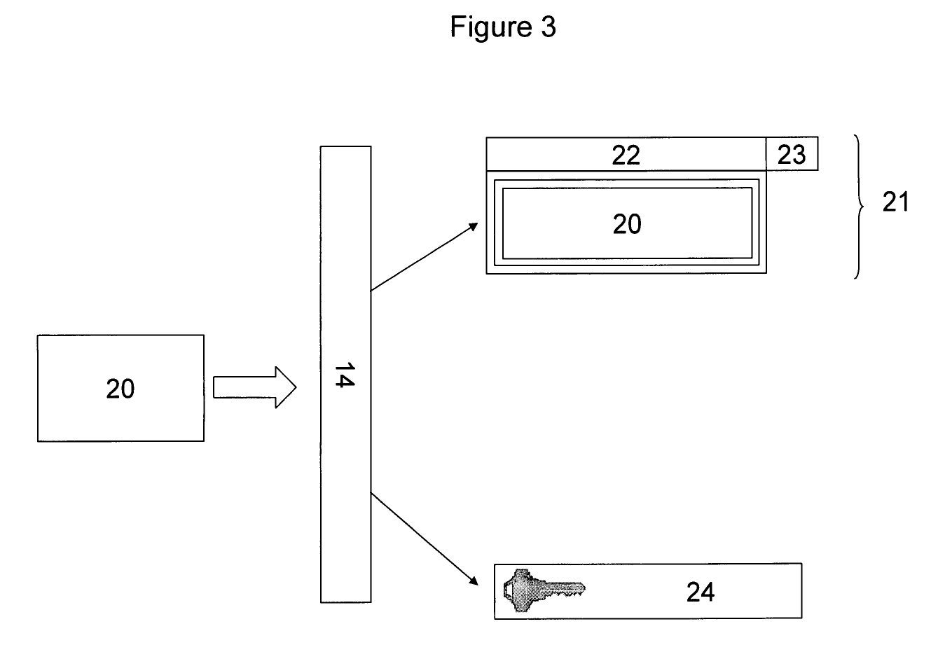

FIG. 3 contains a description of an encryption principle of the files used for achieving the invention;

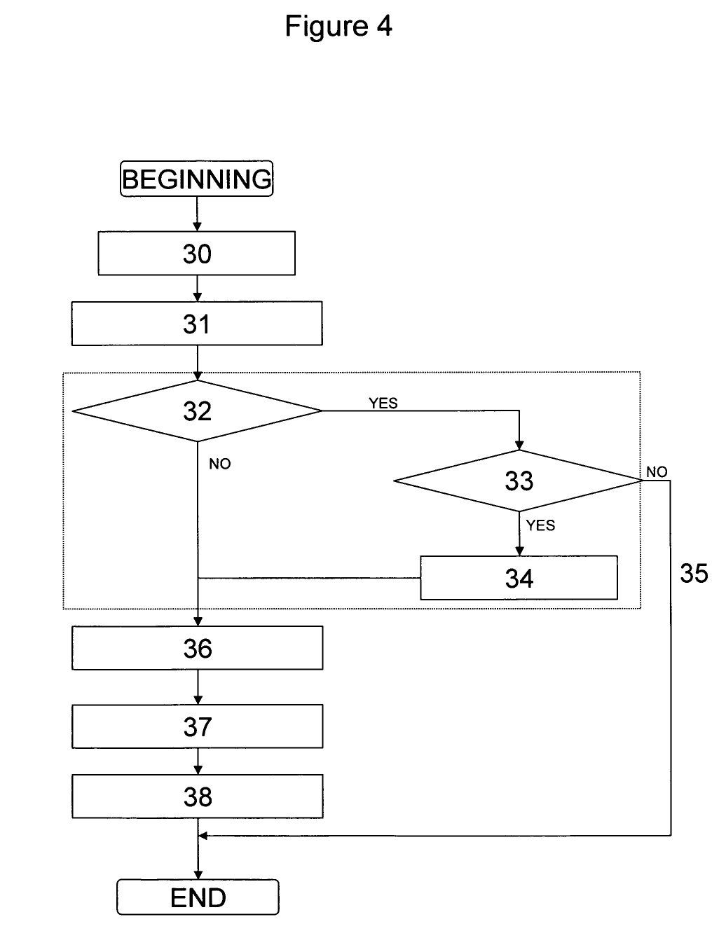

FIG. 4 contains a description of a download request by a user;

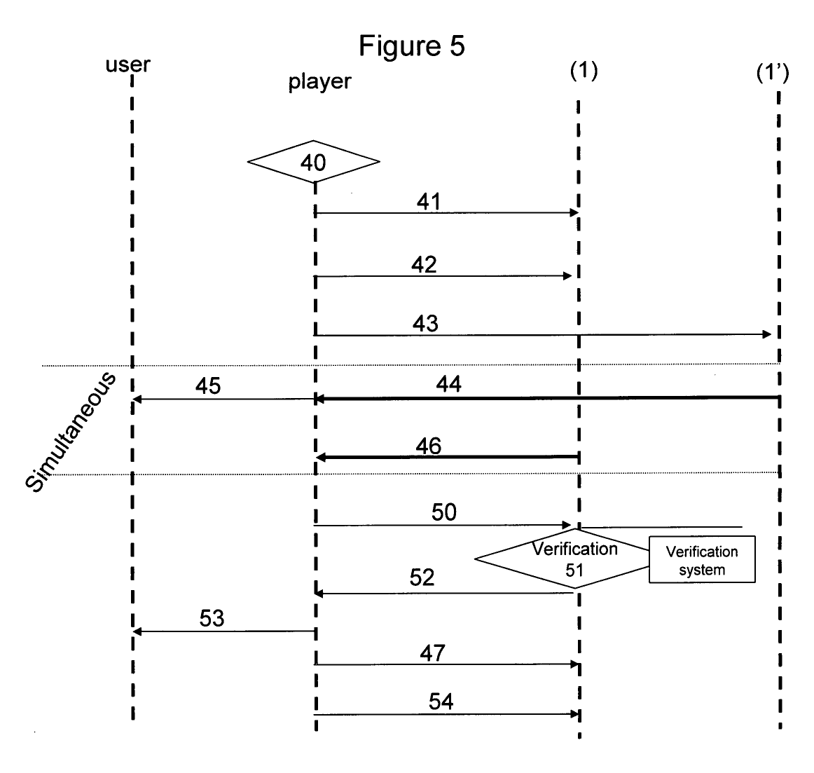

FIGS. 5 to 7 contain descriptions of various modes of implementation of the invention;

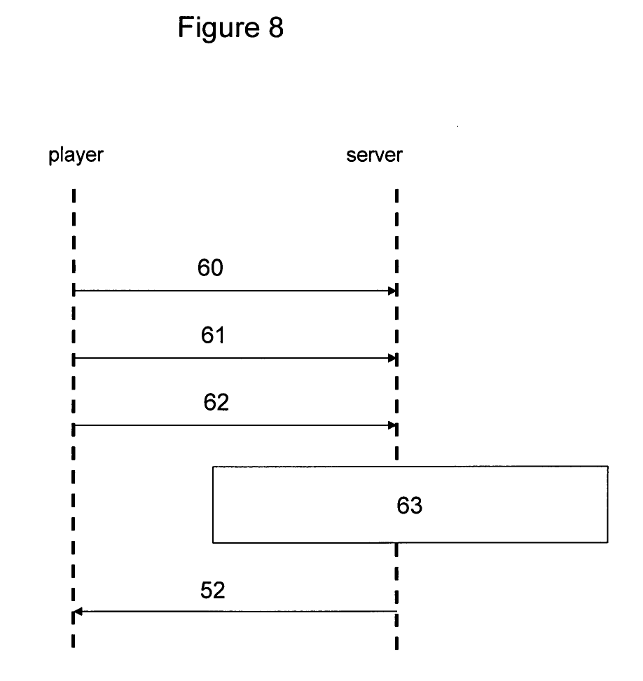

FIG. 8 contains a description of the verifications made before transmitting the decrypting key within the framework of this invention; and

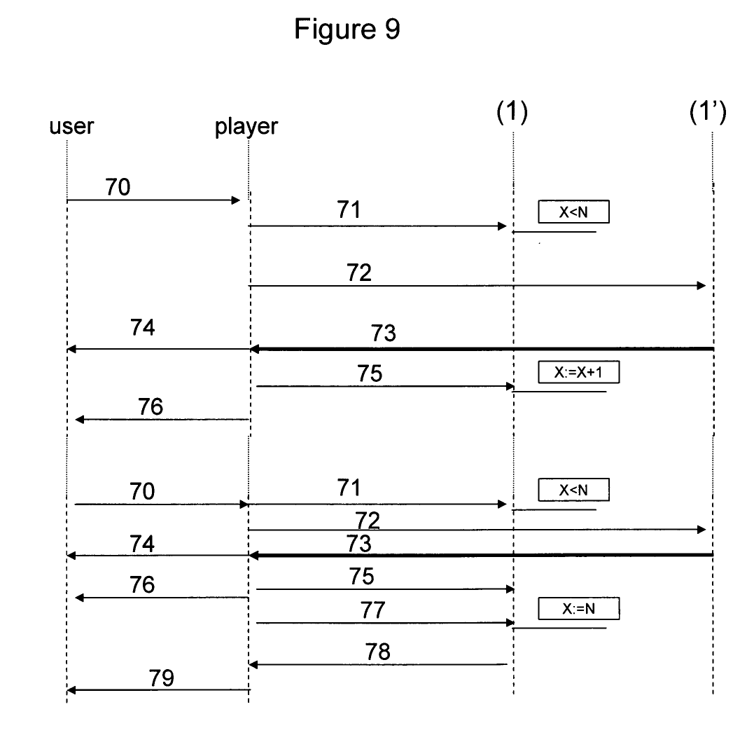

FIG. 9 contains a description of the reading of a file by the user.

This invention implements a process of downloading of digital files which broadcast advertisements during the idle period of navigation, i.e. during the period of time corresponding to the transfer of digital files from the server to the customer.

In order to make these explanations easier to understand fully, the following description shall be limited to the downloading of digital musical files. However, it is obvious that this invention is not limited to the downloading of such musical files. This invention allows for the downloading of all types of digital files such as, for example, video, any type of multimedia digital files, video games, software, documents . . .

In the mode of implementation illustrated at FIG. 1, a system including at least one server connected (1) to a digital network is implemented (5) allowing the downloading process, as for example the Internet or a mobile phone network, and a group of persons (4) using computers connected to said network.

The server (1) is equipped with storage capacity for digital music files, compressed or not, as well as an HTTP server allowing the management of a web site by web producers (2) and of request in the HTTP format. The compressed files may for example be in the MP3 format (MPEG 1 Layer 3) or in an owner format such as, for example, the TMX format, said format including a head line of informations relating to this invention and a body containing the data to be downloaded in encrypted form. The non-compressed files are in original format, generally RAW. The server includes a database which catalogues the totality of the digital music files available on the server. This database may, if needed, link a group of key words to each song, in order to make the association with an advertisement server easier.

In reference to FIG. 2, a MUSIC 1 server is set up to process musical files and delivers multimedia files. A second ADVERTISING server (1) is set up to manage the broadcasted advertisements.

The MUSIC 1 server includes:
a module (11) set up to process the signal for the compression of files in order to obtain files which may be broadcast through different delivery rates according to the wishes of the users (96 Kilobits per second [kbps], 128 kbps, 256 kbps, for example),
a module (12), set up to convert the music file to the right format in order to meet the requirements of the Digital Rights Management, for example to the WMA format (commercial name), the AAC format (commercial name), ATTRAC 3+ (commercial name) or TMX (TOUMIX Owner format),
a database (13), set up to list the musical files, and
an encryption software (14), set up to encrypt said files in TOUMIX format.

The server includes, also, devices (11) and (12) allowing for the compression of the files, from the original format to the compressed format, for example using an MP3 encoder, and devices (14) allowing for the encrypting of said files in TOUMIX owner format.

In reference to FIG. 3, the encrypting of digital file (20) by encrypting module 14 consists in the generation of an encrypting key separate from the file and from the file's encoding, for example in AES 256 bits.

In the owner format, file (20) is encapsulated. The file obtained (21) includes, among other things, a heading (22) relating to the information contained in file (21), along with a field (23) indicating the number of advertisements necessary for the withdrawal of the encapsulation. A single key (24) issued from the encrypting module 14 is associated with each TMX file (21).

In further reference to FIG. 2, the bulk of the advertisements (15) provided by the announcers (3) is stocked in a second server (1′) and shall be broadcast by this process and has access to a server. The server can be imbedded in PHP, Perl, ASP or other equivalent script. A database (16), in the MySQL format for example, stores the bulk of the information relating to the advertisements, for example the routing of the advertisement files, the announcer's name.

The database also stores the bulk of statistical information (17) recorded during the downloads or users' logins to the website where this invention can be downloaded: this user information may be for example the gender, the preferred musical genres, the email address . . .

In one of its versions, the system created pursuant to this invention only implements one server. The advertisement and statistical information databases are then implemented on the same server as the music files.

In another of its versions, several servers are set up on the network in order to provide several access points for the downloading.

The server is accessible via a customer-server interface. For example, this interface is an Internet website.

The user wishing to download music files using this invention shall connect to the website. At the time of his first visit, the user signs up in order to obtain a unique user login identity, allowing future connections.

The server gives the user access, via the Internet website, to the database (13) listing the whole of the available musical recordings. The information contained in this database is varied in order to allow for searches according to different criteria. The information most used shall be, usually, the recording's name, the artist, the album, the musical genre, but this list is not limited as far as exploitable criteria go.

In another mode of implementation, said signing-in stage executes the downloading of a plug-in to the customer terminal of the user. This stage is transparent for the user, i.e. it happens without notice being given to the user. In some cases, warnings from the exploitation system go to the user for the installation of certain components, particularly those using activeX (commercial name). This plug-in necessarily contains functions able to download files, to display the broadcasted advertisement and to decompress the downloaded files.

In one version, the plug-in also comprises an audio and/or user interface, in order to constitute an audio player.

In another mode of implementation, the plug-in is downloaded deliberately by the user. This may be the case when the user, owning a login name for access to the server, wishes to install the device used for this invention onto another computer. To this end, he deliberately downloads and installs the plug-in.

Various stages are implemented pursuant to the invented process, particularly, the downloading of a musical file and the display of an advertisement. In reference to FIG. 4, the general process consists, for the user, in:
connecting (30) to the server via a web page;
clicking (31) on the link to download the chosen music file following theme based requests for example;
an analysis of the customer terminal is operated to determine whether uploading the plug-in is necessary or not (no plug-in or older version) (32):
   where needed, the plug-in is uploaded (33) and installed (34) onto the terminal; The user may refuse the installation (35) in which case the process is aborted,
then, a dialog box inviting the user to choose the file into which the downloaded file shall be saved is displayed (36),
an advertisement is displayed (37) during the downloading of the file,
a window indicating that the download is completed is then displayed (38);
the process is ended.

In reference to FIG. 5, following the selection of a sound track, the user initiates the downloading by clicking for example, on an Internet link with the extension “TLF” or by executing a specific protocol, for example with a “tmx:\\ . . . ” prefix. Upon reading this extension, the plug-in and the associated player start up (40). The plug-in reads the “TLF” file which contains the information such as routing to the musical file on the server or the advertisement to broadcast. If the need arises, this particular function link may contain the information necessary to the downloading (such as the routing to the downloading server, the associated graphic background, the advertisements to broadcast among others).

In another mode of implementation the plug-in requests from the server (1) the data associated to this link (via a (12) HTTP protocol or sockets), the server, referring to its own database, then sends this information.

Optionally, the plug-in presents the Internet user with a request to confirm the download, displaying the additional information, such as the price of the download, etc. The downloading program sends a signal for the creation of a downloading session (41) to the server, in order to ensure the security of the program-server connexions, after validation by the Internet user or directly if a confirmation is not necessary. The program receives a key for the session from the server, that it shall use in all its requests to be identified. At the same time, the server receives a request for the sending of the file to be downloaded (42) from the player.

The server receives an HTTP request from the player for a TMX file and a second PHP type request indicating the name of the TMX file. The server then encodes, if necessary, the musical file (if it is in original format) using the adequate methods, such as a MP3 encoder, then modifies it to the TMX owner format (Toumix) such that it is only exploitable with the aforementioned driver or plug-in.

In a particular mode of implementation, the files contained in the server are directly available in the TMX format.

At the same time (43) a request for advertisement is issued by the specific player to the ADVERTISEMENT server (1′) which interprets the request, selects, using the advertisement database, an advertisement associated with the musical file to be downloaded and all the management information for this advertisement, for example the number of times the file is played with the advertisement. The driver then downloads (44) the advertisement content and displays it (45) for the user to see.

Simultaneously, the driver downloads (46) the music file.

In another mode of implementation, the downloading of advertisement contents takes place before the downloading of the musical file in order for the advertisement to be shown to the user during the time of downloading. These advertisement contents may be, indifferently, video sequences, cartoon sequences, “flash” animations, pictures, banners, . . .

In another version, the advertisement contents are broadcast by video stream and displayed in real time whilst the musical file is downloaded.

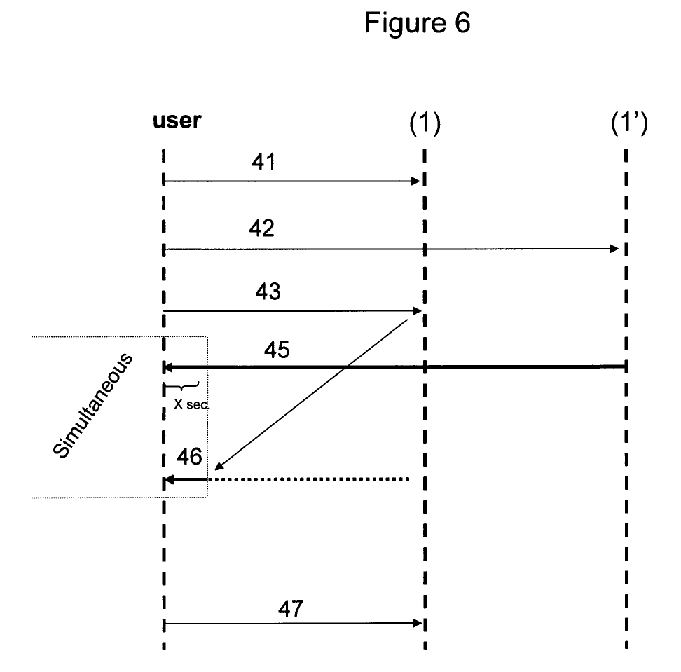

In another mode of implementation illustrated in FIG. 6, the downloading (46) of said content is initiated “x” seconds before the end of the advertisement broadcasting (45). The value “x” is determined empirically in order for the downloading of the file and the broadcasting of the advertisement to end at the same time. For example “x” may be calculated by dividing the size of the file to download by the download rate available to the user. The advantage of such a solution is that in the case of an interruption in the broadcasting of the advertisement, the musical file is not entirely downloaded to the customer's terminal. The request for the content arriving at the contents server is postponed and takes place only after the advertisement server has sent a request taking place “x” seconds before the end of the broadcasting of the advertisement. At the end of the process, the downloading session is closed (47).

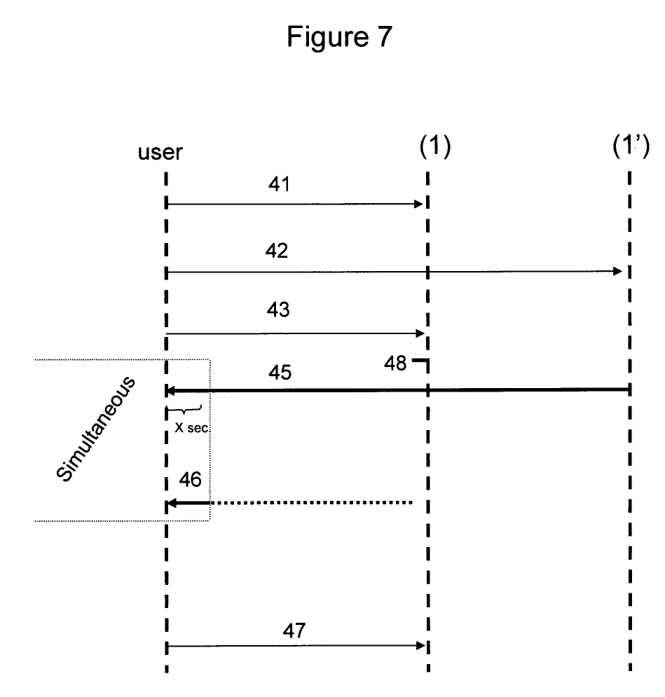

In a version illustrated at FIG. 7, the download request is sent at the same time as the request for the broadcast of the advertisement, but the downloading (46) of the content is blocked (48) and starts again only “x” seconds before the end of the broadcasting of the advertisement (45).

The driver displaying the advertisement may be submitted to rules in such a way that the window displaying the advertisement:
is visible continuously during the download,
cannot be hidden by other windows opened on the user's terminal
may not be moved outside the “Visible” window on the user's terminal
may not be reduced to the toolbar of the exploitation system
interrupts the downloading of the music file download if it is closed.

Many IT possibilities exist to implement these stages, for example, functions relating to the properties of Windows.

On FIG. 5, when the download has ended and the advertising has not been interrupted, the player requests (50) the decrypting key for the file from the server (1). The server sends (52) the key if all the conditions have been met (verification stage 51). Upon reception, the key is used to decrypt (53) the owner format and access the contents of the downloaded file. Following the decrypting, the reader makes the play back commands available. The user may thus listen to the file, the decrypting being operated in real time by said reader and the means being provided by its plug-in.

The displaying of the advertisement may prolong itself or give way to the display of other information, such as the jacket of the CD from which the soundtrack is taken.

The downloading session is then closed (47) and, possibly, statistics are sent (54) by the player to servers (1) and/or (1′).

The checking of the conditions for the sending of the decrypting key is illustrated in FIG. 8. The check may only take place if the checking module has received notification of the signal for advertisement run (60), for advertisement download completed (61) and for request for a decrypting key (62) by the servers management software (1′). On the basis of the information transmitted in these requests, the module operates checks (63) as follows:
the IP address of the user formulating the request is consistent with that of the user requesting the advertisement,
the time elapsed since the notification (60) is longer than the time for which the advertisement has lasted.

If this check is positive, the decrypting key is sent (52).

Additional functions used by the plug-in allow to save the downloaded file in the encrypted TMX format, as delivered by the server or in another electronic music format, the most famous being “mp3” and “wav”. As long as the file with advertisement has not been played a certain number of times, it may only be saved under the owner format. The reader saves the downloaded digital musical file and adds the information concerning the downloaded advertisement to the owner heading, that is to say, the off-line version of the advertisement (in other words the advertisement that shall be broadcast if the user is not connected to the Internet at the time the file is next read), and the number of remaining playbacks.

Each new playback of this file may only be done using the specific reader associated to the plug-in and initates the display of an advertisement. Either the computer is disconnected from the Internet and the advertisement is a pre-downloaded flash animation, or the computer is connected to the Internet and the advertisement can be a continuous flow video broadcast. Once all the playbacks have been completed, the file may be saved under another audio format as mentioned previously, in consistency with a DRM server that may be defined in the specific player or the server (1).

These additional functions and the use of the files are illustrated on FIG. 9.

(70): the user requests the playback of a downloaded file from the player,

(71): the player checks the state of management of the digital rights on the file with server (1), this server indicates that less than N viewings of advertisements has occurred for this file,

(72): the player operates a request for advertising contents from the server ADVERTISING (1′). Upon receipt of the advertisement (73), the player displays it (74),

(75): the signal indicating the end of the advertisement is transmitted to the server in order to update the number of readings,

(76): the user may then read his file.

Then,

(77): once the number of readings operated matches the number of readings at which it has been agreed to unblock the file, the player requests the decrypting key,

(78): after checking, the key is returned to him,

(79): the user may export permanently the content encapsulated under the TOUMIX format in its original format (for example mp3).

During the use of the reader, the reader implements ways to collect statistics, for example the number of advertisements displayed, the number of clicks on the displayed advertisements to go to the announcer's website.

When the user connects to said website, the reader transmits the totality of the statistics it has collected during its use. The server stores them in its database of statistics as mentioned previously. The use of a mySQL database facilitates the exploitation of this information.

1. A method of downloading at least one digital file on a digital network, using at least one server and a remote device, connected to said network, comprising the steps of downloading a digital file by the remote device and displaying an advertisement,
wherein:
said advertisement display step takes place during the downloading step,
said advertisement is not integrated to the downloaded digital file and is streamed over the network, and
the method implements, at the level of the digital file, methods for blocking their use.

2. A method of downloading at least one digital file according to claim 1, distinguished by the fact that said methods for blocking the use of the digital file, include a step of encrypting the file to download.

3. A method of downloading at least one digital file according to claim 1, characterised by the fact that said methods for blocking the use of the file, include a step of encapsulation, in an owner format, of said file to download.

4. A method of downloading at least one digital file according to claim 1, distinguished by the fact that said methods implemented for blocking the use of the digital file are deactivated by use of a specific plug-in.

5. A method of downloading at least one digital file according to claim 1, distinguished by the fact that the file is a multimedia file.

6. A method of downloading at least one digital file according to claim 5, characterised by the fact that the multimedia file is in a MP3 format.

7. A method of downloading at least one digital file, according to claim 1, distinguished by the fact that the digital network is the Internet.

8. A method of downloading according to claim 1, distinguished by the fact that said download of the file is launched after the display of the advertisement in such a way that said download and the display of the advertisement end at more or less the same time.

9. A method of downloading according to claim 1, distinguished by the fact that it includes, following the step of advertisement display and in answer to a request from the remote device, a step of transmission of a decrypting key by the server to the remote device if the following parameters are validated:
the IP address of the requesting party matches the IP address of the user requesting the advertisement, and
the advertisement has been entirely broadcast.

10. A method according to claim 1, further including a step of withdrawal of the aforementioned methods for blocking the use of the file once the number of entire broadcasts unlocked by the execution of said file reaches a pre-determined threshold.
